(19) United States
(12) Patent Application Publication
(10) Pub. No.: US 2025/0252968 A1
(43) Pub. Date: Aug. 7, 2025

(54) SYNTHETIC VOICE FRAUD DETECTION

(71) Applicant: Wells Fargo Bank, N.A., San Francisco, CA (US)

(72) Inventor: Ajit Gaddam, Danville, CA (US)

(21) Appl. No.: 19/046,053

(22) Filed: Feb. 5, 2025

Related U.S. Application Data
(60) Provisional application No. 63/551,023, filed on Feb. 7, 2024.

(51) Int. Cl. G10L 25/69; G10L 17/04; G10L 17/26

(52) U.S. Cl. CPC G10L 25/69; G10L 17/04; G10L 17/26

(57) ABSTRACT

Systems and techniques may generally be used for detecting a spoofing or mimicking attempt of a customer or employee voice. A method for training a machine learning model to detect a fraudulent attempt to mimic an employee using a synthetic voice copy includes receiving a voice sample of an employee of an enterprise, normalizing the voice sample through a signal processing pipeline, generating a synthetic voice sample using the voice sample, training a model to identify whether received audio includes a synthetically generated voice sample using the voice sample and the synthetic voice sample, and outputting the trained model.

### CLAIM OF PRIORITY

This application claims the benefit of priority to U.S. Provisional Application No. 63/551,023 filed Feb. 7, 2024, titled “SYNTHETIC VOICE FRAUD DETECTION,” which is hereby incorporated herein by reference in its entirety.

### BACKGROUND

Artificially or synthetically generated or manipulated voice recordings are used for fraudulent purposes. Advances in AI technology have made it possible to create highly convincing synthetic voices that can mimic real individuals. These synthetic voices are used to attempt to fraudulently gain access to voice-based identity verification systems for theft or financial fraud. As synthetic voice technology becomes more sophisticated, detecting synthetic voices becomes more difficult.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a system diagram for synthetic voice fraud detection in accordance with some examples.

FIG. 2 illustrates a data flow diagram for synthetic voice fraud detection in accordance with some examples.

FIG. 3 illustrates a machine learning engine for training and execution related to verifying a caller at a call center in accordance with some examples.

FIG. 4 illustrates a flowchart showing a technique for training a machine learning model to detect a fraudulent attempt to mimic an employee using a synthetic voice copy in accordance with some examples.

FIG. 5 illustrates a flowchart showing a technique for detecting a spoofing attempt of a customer vocalization in accordance with some examples.

FIG. 6 illustrates generally an example of a block diagram of a machine upon which any one or more of the techniques discussed herein may perform in accordance with some examples.

### DETAILED DESCRIPTION

In recent years, there has been an increase in fraudulent activities involving the use of artificial intelligence technologies to create and manipulate voice recordings for deceptive purposes. Malicious actors are employing AI-powered voice synthesis and cloning techniques to generate synthetic voice replications of legitimate customers and employees. These synthetic voices can be generated using sample audio data from the target individual, often obtained through public recordings or social media content.

The fraudulent synthetic voices can mimic the basic vocal characteristics of the target individual, including accent, cadence, or emotional inflection that serve as identifiers of authentic voice communication. This level of voice synthesis enables bad actors to circumvent voice-based security measures and verification systems by creating synthetic speech that can pass both human and automated authentication processes.

The systems and techniques described herein may prevent or identify an attack on a voice authentication system. For example, an attack may attempt to circumvent voiceprint authentication such as when an employee calls a Help desk. This attack may occur using a cloned voice of an employee. Success of the attack may be measured by whether the attack passes a voice authentication test. The systems and techniques described herein may detect that this attack includes a synthetic attack.

The systems and techniques described herein may prevent or identify an attack in a call center or interactive voice response channel, by determining whether a caller is genuine or a fraudster. The genuine caller may be identified based on a mapping. The identification of the fraudster may include using data from a telecom company that is operating a phone number of the caller, for example using a device validation to confirm whether phone number 123-456-7890 is registered on a telecom platform to an identity of the caller. The voice of the caller may be validated as genuine or fraud in addition to the phone number validation.

Shown below in Table 1 are various scenarios at enrollment that a user may perform. A completed scenario (a user may perform more than one) may be used to later test whether a user interaction is legitimate. A first scenario includes asking the user to register their voice, device, and Automatic Number Identification (ANI) with more than 10 seconds of speech. A second scenario includes asking the user to complete more than 5 seconds of speech, but without the device or ANI registration, for example. A third scenario includes capturing a voice sample exceeding four seconds along with a verification test (e.g., device, ANI, a text verification, an email verification, etc.). A fourth scenario is the third scenario but with a shorter sample under four seconds. A fifth scenario includes enrolling the user with only a low quality verification test when background noise is present. In some examples, a set of scenarios may be required (e.g., two or more, three or more, all, etc.) so that the user may be authenticated in different calling situations (e.g., when the user is in a public place, when the user is making a large transaction, etc.).

In some examples, as shown below in Table 1 various negative or fraud scenarios may be designed to illustrate examples of potential fraud (e.g., for training a system). For example, a first scenario may include a tester attempting to enroll with insufficient voice data (e.g., less than 5 seconds of speech). A second scenario may include a tester injecting an AI-generated voice sample through the tester's automatic number identification (ANI). In this example of synthetic voice, an extended sample of 60-90 seconds of net speech may be used. A third scenario may include injecting a real recorded voice sample of the tester through the tester's ANI. A fourth scenario may include a verification test with a different live voice. For example, in this fourth scenario, an impersonation test may be conducted to evaluate effectiveness of a system in identifying and preventing a false acceptance when an impersonator speaks instead of the tester, where the impersonator may speak in a live environment.

TABLE 1

| | | |
|---|---|---|
| ID | Scenario | Scenario Description |

Enrollment & Verification Scenarios

| | | |
|---|---|---|
| P1 | Enroll (1/2) | Tester will enroll their Voice, Device and ANI with >10 sec. |
| P1-b* | Enroll (2/2) | Tester will enroll with >5 sec. |
| P2 | Verify >4 sec. | Verification Test with Net Speech >4 seconds |
| | NS | |
| P3 | Verify <4 sec. | Verification Test with Net Speech <4 seconds |
| | NS | |
| P4 | Background | Low call quality verification test when background noise is present |
| | noise | |

Negative/Fraud Scenarios

| | | |
|---|---|---|
| N1 | Enroll <5 sec. | Tester tries enrolling with <5 seconds of Net Speech (NS) |
| | NS | |
| N2 | Synthetic | Inject synthetically generated voice sample through the tester's ANI. |
| | Voice | The synthetic voice injection test is useful for evaluating the efficacy of |
| | | Fraud and IVR platforms in detecting deep fakes, an area of increasing |
| | | importance given the rapid advancements and widespread use of AI by |
| | | bad actors. For this test, synthetic voice samples incorporated 60-90 |
| | | seconds of net speech from the testers. |
| N3 | Recorded | Inject tester's real recorded voice sample through the tester's ANI |
| | Voice | |
| N4 | Impersonation | Verification Test with a different “live” voice. |
| | | The impersonation tests were conducted to evaluate the effectiveness of |
| | | systems in identifying and preventing false acceptances when an |
| | | impersonator speaks “live” instead of the actual tester. |

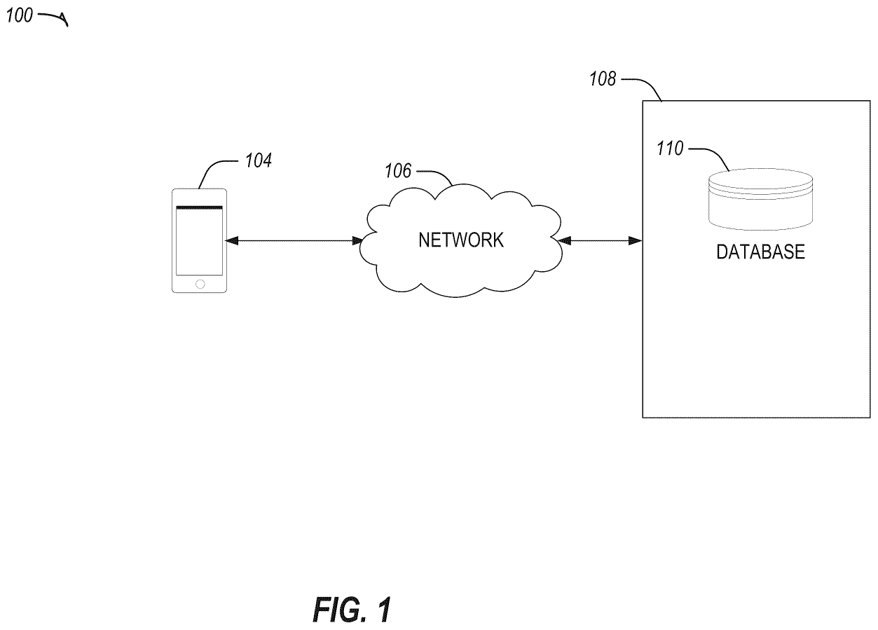

FIG. 1 illustrates a system 100 for synthetic voice fraud detection in accordance with some examples. The system includes a user device 104 (e.g., for calling a help desk, recording voice, for accessing a banking app or website, or the like). The user device 104 may communicate via a network 106 with a server 108 (e.g., a banking server, such as an authentication server, an app server, a fraud server, a help desk server or service, etc.), which may include, be, or be communicatively coupled to a database 110. The server 108 may include a help desk service to connect the user device 104 to a help desk operator.

The system 100 may include a security layer, including authentication combining voice or device verification, synthetic voice detection capability, integration with a telecom carrier validation system, analysis of a call pattern, or checking against a fraud attempt. The system 100 may provide protection against voice-based fraud attempts while maintaining operation of a help desk or customer service functions. For example, the system 100 may provide an alert that fraud has occurred or is likely to have occurred. The alert may trigger an action, such as placing a hold on an account, rejecting an authentication attempt, disallowing further attempts to login from an IP address, or the like.

In some examples, a voice authentication request is validated regardless of source or previous authentication status. The system 100 may adjust an authentication requirement based on risk level, transaction type, or pattern. In some examples, the system may implement authentication during a help desk session, analyzing a voice pattern to detect a potential attack or unauthorized transfer.

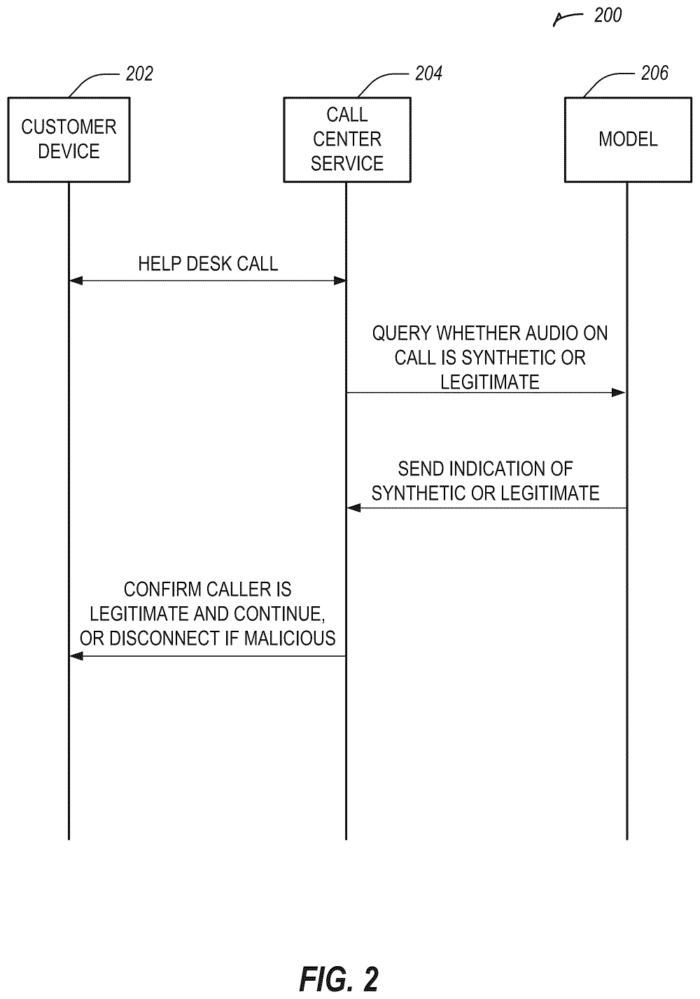

FIG. 2 illustrates a data flow diagram 200 for synthetic voice fraud detection in accordance with some examples. The data flow diagram 200 includes a customer device 202 in communication with a call center service 204. The call center service 204 is further in communication with a trained model 206. The customer device 202 or the call center service 204 may initiate a help desk call (or other type of call, such as a fraud alert call, an account opening or question call, etc.). The call center service 204 may capture a recording or audio of a user of the customer device 202 (or audio from the call), such as with the consent of the user, and send the recording or audio to the model 206 to determine whether the recording or audio is legitimate or synthetic. The model 206 may send to the call center service 204 an indication of whether the recording or audio is legitimate or synthetic. The call center service 204 may confirm the user is legitimate or continue when the model 206 indicates the call is legitimate, or disconnect the call if the model 206 indicates the call is malicious.

In some examples, the call center service 204 may include a computer-based calling application that may operate through a web browser or standalone software interface (e.g., call center software). The call center service 204 may establish a help desk support call where a customer service representative may assist with technical or account access, an account verification call service where identity confirmation may be determined, or a customer service inquiry where general assistance may be provided. The call center service 204 may use a call routing protocol to direct the communication to an appropriate service representative based on the session type after verification.

The model 206 may receive audio data from the call center service 204 and evaluate a voice segment for authenticity. In an example, the model 206 may generate an authenticity score based on whether the call is synthetic or legitimate, which may be sent to the call center service 204. The authenticity score may indicate a likelihood of whether audio is legitimate or synthetic.

When the model 206 indicates a legitimate call, the call center service 204 may proceed with a call handling procedure or customer authentication (e.g., without indicating to the customer device 202 that the determination has occurred, where the determination may occur in a manner that is opaque to a customer). When the model 206 detects a synthetic or fraudulent call, the call center service 204 may activate a security protocol for the call, such as call termination, generating a fraud alert, documenting the fraudulent access attempt, suspending an IP address or phone number associated with the customer device 202, activating an additional security protocol (e.g., sending a request to the customer device 202 for additional information, activating another factor of authentication, etc.), or the like.

In some examples, the data flow process may operate in real-time, allowing for immediate threat detection or response while maintaining efficient call center operations. In some examples, the call center service 204 may maintain a log of voice authenticity determinations, which may be used for future model training (e.g., to retrain the model 206) or for a security audit purpose.

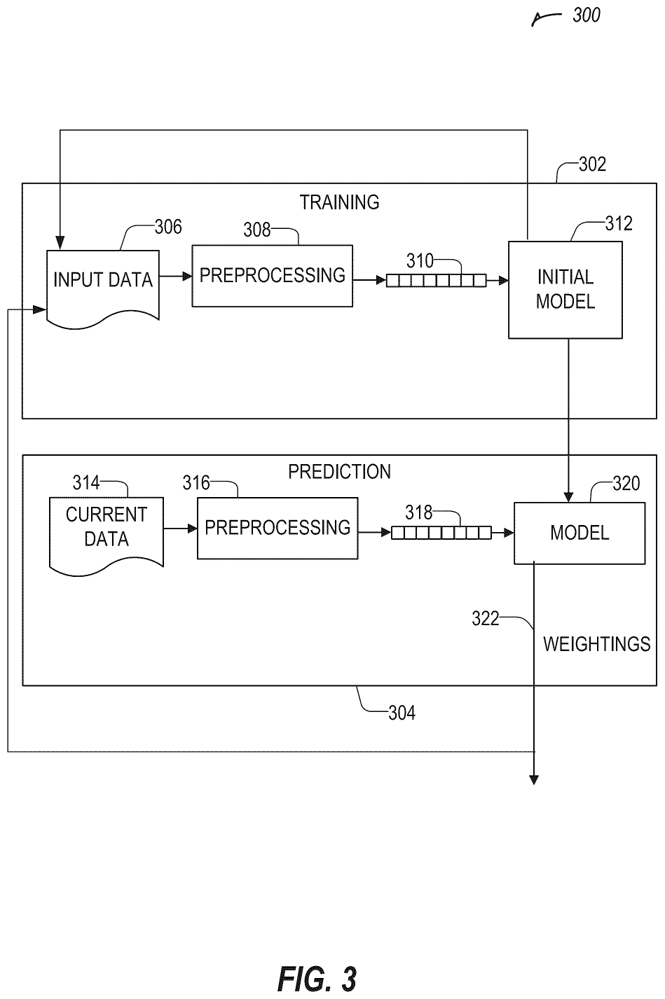

FIG. 3 illustrates a machine learning engine for training and execution related to verifying a caller at a call center in accordance with some examples.

The machine learning engine may be deployed to execute at a mobile device (e.g., a cell phone) or a computer (e.g., an orchestrator server). A system may calculate one or more weightings for criteria based upon one or more machine learning algorithms. FIG. 3 shows an example machine learning engine 300 according to some examples of the present disclosure.

Machine learning engine 300 uses a training engine 302 and a prediction engine 304. Training engine 302 uses input data 306, for example after undergoing preprocessing component 308, to determine one or more features 310. The one or more features 310 may be used to generate an initial model 312, which may be updated iteratively or with future labeled or unlabeled data (e.g., during reinforcement learning), for example to improve the performance of the prediction engine 304 or the initial model 312. An improved model may be redeployed for use.

The input data 306 may include voice data (e.g., a live call, a recorded call, a voice sample, etc.), a device identifier, a call originator number, voice samples, or the like. In the prediction engine 304, current data 314 (e.g., a current voice sample from a call or recording) may be input to preprocessing component 316. In some examples, preprocessing component 316 and preprocessing component 308 are the same. The prediction engine 304 produces feature vector 318 from the preprocessed current data, which is input into the model 320 to generate one or more criteria weightings 322. The criteria weightings 322 may be used to output a prediction, as discussed further below.

The training engine 302 may operate in an offline manner to train the model 320 (e.g., on a server). The prediction engine 304 may be designed to operate in an online manner (e.g., in real-time, at a mobile device, on a wearable device, etc.). In some examples, the model 320 may be periodically updated via additional training (e.g., via updated input data 306 or based on labeled or unlabeled data output in the weightings 322) or based on identified future data, such as by using reinforcement learning to personalize a general model (e.g., the initial model 312) to a particular user or purpose.

Labels for the input data 306 may include whether a voice recording or call was legitimate or malicious (e.g., faked, spoofed, pre-recorded, etc.).

The initial model 312 may be updated using further input data 306 until a satisfactory model 320 is generated. The model 320 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 302 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 302. In an example embodiment, a regression model is used and the model 320 is a vector of coefficients corresponding to a learned importance for each of the features in the vector of features 310, 318. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

Once trained, the model 320 may output a prediction of whether a call or recording is legitimate or malicious (e.g., faked, spoofed, pre-recorded, etc.). The model 320 may be retrained over time, in some examples (e.g., using further call data, examples of malicious voice activity, etc.).

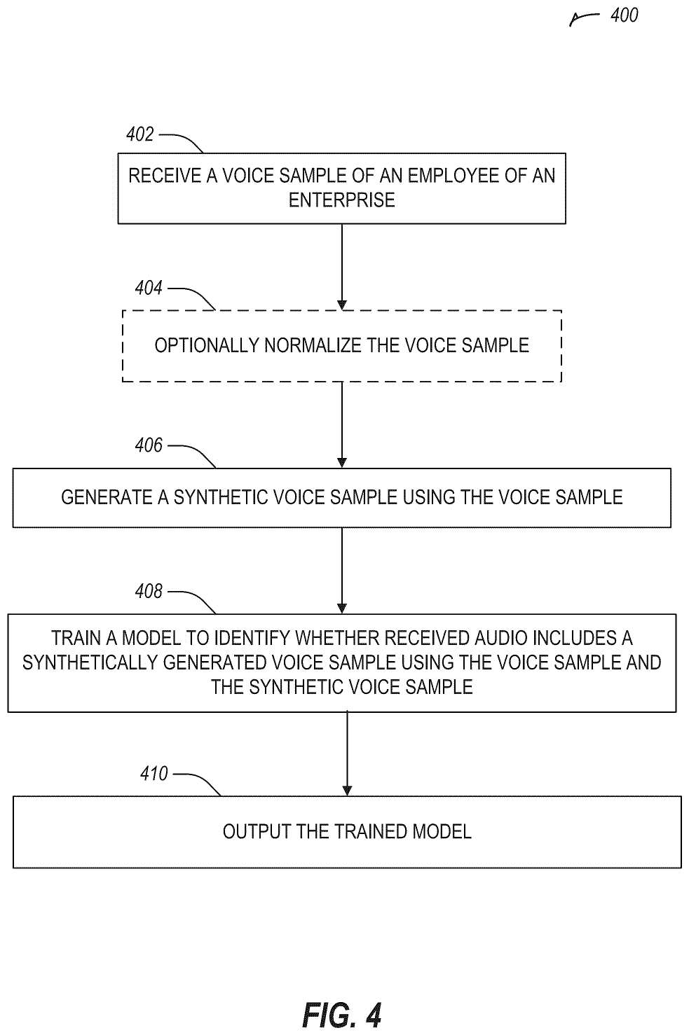

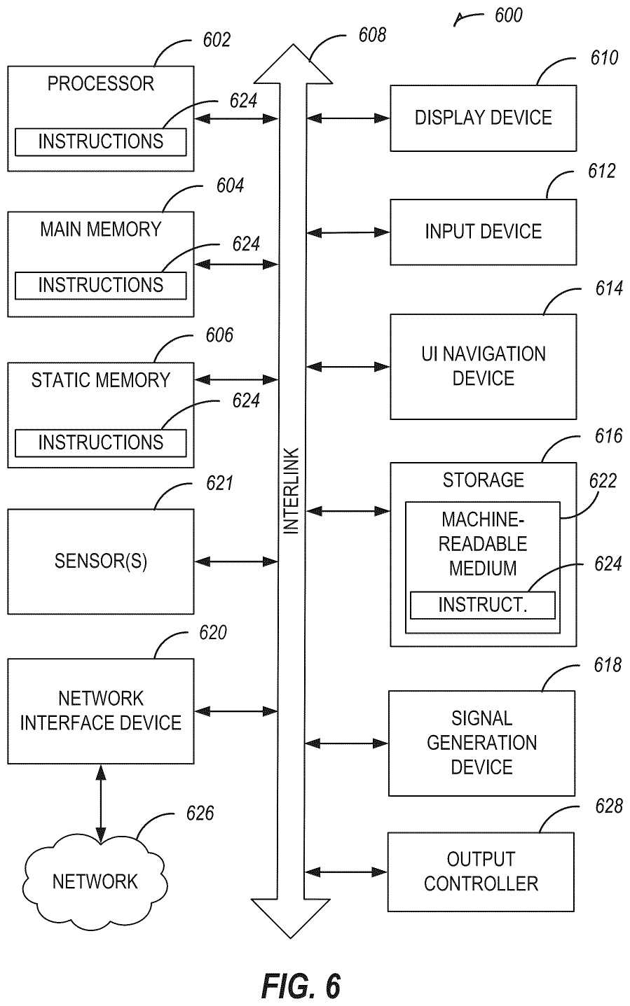

FIG. 4 illustrates a flowchart showing a technique 400 for training a machine learning model to detect a fraudulent attempt to mimic an employee using a synthetic voice copy. In an example, operations of the technique 400 may be performed by processing circuitry, for example by executing instructions stored in memory. The processing circuitry may include a processor, a system on a chip, or other circuitry (e.g., wiring). For example, technique 400 may be performed by processing circuitry of a device (or one or more hardware or software components thereof), such as those illustrated and described with reference to FIG. 1 or 6.

The technique 400 includes operation 402 to receive a voice sample of an employee of an enterprise. The voice sample may include a set of voice samples, such as at least two voice samples of differing duration (e.g., one less than four seconds, one over five seconds, one over ten seconds, etc.). The voice sample may include a low quality verification test sample, for example with background noise.

The technique 400 may include capturing a voice sample under one or more conditions for training, such as a short-duration sample from 2-4 seconds, a medium-duration sample of 5-9 seconds, or an extended-duration sample of 10 seconds or more. During inference with a trained model, a minimum duration may be set for a particular task, such as the extended-duration sample for enrollment, the short-duration sample when a device has already been used to authenticate a user, or the medium-duration sample for a first authentication at a device. A sample may be captured with a user speaking with a particular emotional state, such as neutral, stressed, or excited condition. Samples may be captured in different acoustic environments, such as an office setting, an outdoor location, a vehicle, etc.

The technique 400 includes operation 404 to normalize the voice sample. In some examples, preprocessing may be used to apply amplitude normalization to adjust the voice sample volume to a standard reference level.

The technique 400 includes operation 406 to generate a synthetic voice sample using the voice sample. The synthetic voice sample may be generated by modifying one or more aspects of the voice sample, such as changing a volume (e.g., of speech, of background noise), changing a tone of speech, adding or removing background noise or a portion of background noise, adding or removing a sound (e.g., a word or number), slowing down or speeding up the voice sample, changing a timbre of the voice sample, or the like.

The technique 400 includes operation 408 to train a model to identify whether received audio includes a synthetically generated voice sample using the voice sample and the synthetic voice sample. The model may be trained using the voice sample and the synthetic voice sample as inputs, labeled as being authentic or synthetic. For a legitimate voice sample, the training process may apply a positive weight factor to reinforce authentic speech pattern recognition. For a synthetic voice sample, the training process may apply a negative weight value to the synthetic voice sample. A validation operation may be used to evaluate model classification accuracy during or after the training phase.

The technique 400 includes operation 410 to output the trained model. The technique 400 may include an operation to receive a second voice sample from a person other than the employee, and determine whether the second voice sample is a match (e.g., to the first voice sample, is a synthetic or authentic voice, etc.) using the model (e.g., for validation of the model). The technique 400 may include testing a second voice sample from the employee and determining whether the second voice sample is a match (e.g., to the first voice sample, is a synthetic or authentic voice, etc.) using the model.

In some examples, the technique 400 may include a challenge-response scenario where a tester attempts an impersonation technique, including mimicking the employee's speech pattern, attempting to modify a voice characteristic, or using a particular speaking style.

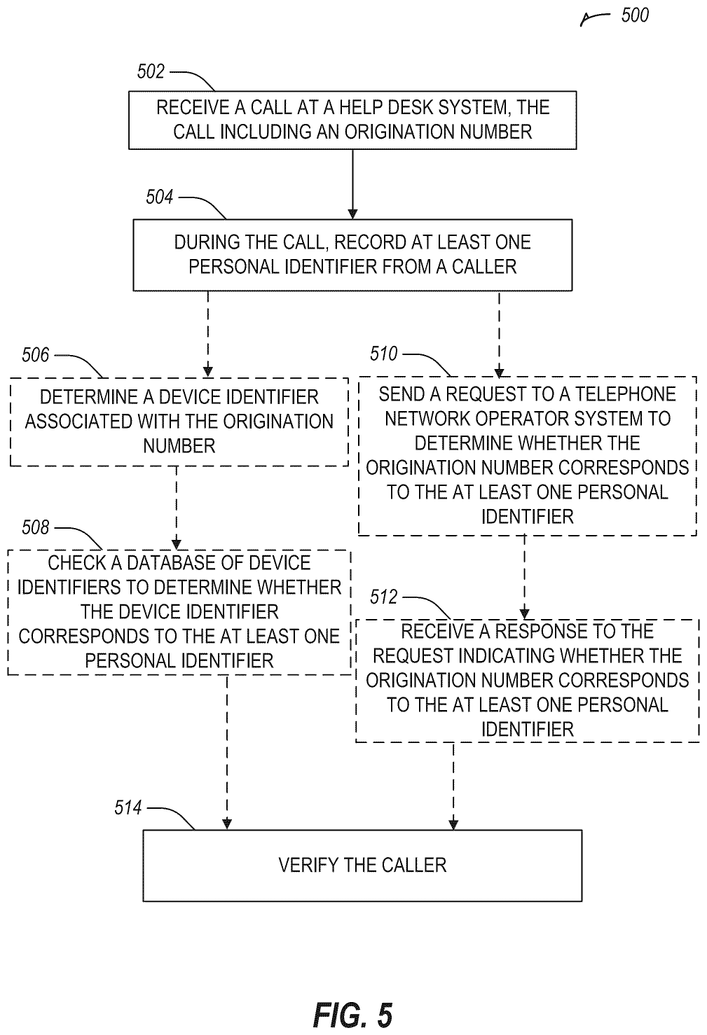

FIG. 5 illustrates a flowchart showing a technique 500 for detecting a spoofing attempt of a customer vocalization in accordance with some examples. In an example, an operation of the technique 500 may be performed by processing circuitry, for example by executing an instruction stored in memory. The processing circuitry may include a processor, a system on a chip, or other circuitry (e.g., wiring). For example, the technique 500 may be performed by processing circuitry of a device (or one or more hardware or software components thereof), such as those illustrated and described with reference to FIG. 1 or 6.

The technique 500 includes an operation 502 to receive a call at a help desk system, the call including an origination number. The system may capture other call metadata including carrier information, a routing path, a network characteristic, a caller identifier (e.g., name), etc.

The technique 500 includes an operation 504 to, during the call, record at least one personal identifier from a caller (e.g., a voluntarily proffered personal identifier, such as a first name, last name, location detail, account or other number, etc.). In some examples, operation 504 may use speech-to-text processing and semantic analysis to capture or categorize a type of personal identifier recorded.

The technique 500 includes an optional operation 506 to determine a device identifier associated with the origination number. The device identifier may be prearranged with a customer to associate with the origination number, in some examples. The device identifier may include a hardware-based identifier for a particular device, such as a MAC address. The device identifier may be associated with an IP address, a location, etc.

The technique 500 includes an optional operation 508 to check a database of device identifiers to determine whether the device identifier corresponds to the at least one personal identifier. In some examples, optional operation 508 may include using a checking technique that accounts for a variation in identifier format, a partial match, or a historical device-identifier relationship.

The technique 500 includes an optional operation 510 to send a request to a telephone network operator system to determine whether the origination number corresponds to the at least one personal identifier. The system may use a standardized telecommunications protocol, including Signaling System No. 7 (SS7), SIGTRAN, a REST API, or the like to establish a secure communication channel with a carrier network while maintaining data privacy requirements.

The technique 500 includes an optional operation 512 to receive a response to the request indicating whether the origination number corresponds to the at least one personal identifier. In an example, the response may indicate a partial or inconclusive carrier response, and the technique 500 may include using operations 506 and 508 as a replacement verification determination.

The technique 500 includes an operation 514 to verify the caller (e.g., in response to operation 508 or 512). The caller may be verified in operation 514 in response to the device identifier corresponding to the at least one personal identifier in operation 508, in response to the response matching the at least one personal identifier in operation 512, or in response to both. The device identifier or the origination number may correspond to the at least one personal identifier when a number associated with the at least one personal identifier matches. For example, the device identifier may be 1234 or the origination number may be 612-555-1234. The at least one personal identifier may be used to obtain a saved device identifier or origination number associated with the at least one personal identifier (e.g., in a database). When the saved information matches 1234 or 612-555-1234, the caller may be verified in operation 514.

The technique 500 may combine a result from a device identifier validation, a carrier verification response, or a voice authentication result to generate an overall verification of the caller. In some examples, the technique 500 includes an operation to use a threshold based on a transaction

In some examples, the technique 500 includes operation 506 and 508 but not operation 510 and 512, while in other examples, the technique 500 includes operation 510 and 512 but not operation 506 and 508. In still another example, the technique 500 includes all of operations 506, 508, 510, and 512. For example, the technique 500 may include validating a customer by matching their mobile device's unique hardware signature or historical usage pattern against a registered profile in the database, which may be used for a frequent customer using a consistent device.

In another example, the technique 500 may include performing carrier-based verification only through operation 510 and 512, such as for a new device or a first-time caller. For example, when a customer calls from a new phone number, the technique 500 may include omitting device verification.

In still another example, the technique 500 may include using operations 506, 508, 510, and 512, such as for a high-risk transaction or a sensitive account change. For example, when a customer requests a large wire transfer, the technique 500 may include verifying that the device identifier corresponds to the profile and confirming with the carrier that the originating number corresponds to the profile, creating multiple layers of authentication for enhanced security.

FIG. 6 illustrates generally an example of a block diagram of a machine 600 upon which any one or more of the techniques (e.g., methodologies) discussed herein may perform in accordance with some examples. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

The following, non-limiting examples, detail certain aspects of the present subject matter to solve the challenges and provide the benefits discussed herein, among others.

Example 1 is. A method for training a machine learning model to detect a fraudulent attempt to mimic an employee using a synthetic voice copy, the method comprising: receiving a voice sample of an employee of an enterprise; normalizing the voice sample; generating a synthetic voice sample using the normalized voice sample; training the machine learning model to identify whether received audio includes, a synthetically generated voice sample using the voice sample and the synthetic voice sample; and outputting the trained machine learning model.

In Example 2, the subject matter of Example 1 includes, wherein the voice sample is positively weighted for training the machine learning model.

In Example 3, the subject matter of Examples 1-2 includes, wherein the synthetic voice sample is negatively weighted for training the machine learning model.

In Example 4, the subject matter of Examples 1-3 includes, receiving a second voice sample from a person other than the employee, and determining whether the second voice sample is a match using the trained machine learning model.

In Example 5, the subject matter of Examples 1-4 includes, testing a second voice sample from the employee, and determining whether the second voice sample is a match using the trained machine learning model.

In Example 6, the subject matter of Examples 1-5 includes, wherein the voice sample includes a set of voice samples including at least two voice samples of differing duration.

In Example 7, the subject matter of Examples 1-6 includes, wherein the voice sample includes a low quality verification test sample with background noise.

Example 8 is at least one non-transitory machine-readable medium including instructions for training a machine learning model to detect a fraudulent attempt to mimic an employee using a synthetic voice copy, which when executed by processing circuitry, cause the processing circuitry to perform operations comprising: receiving a voice sample of an employee of an enterprise; normalizing the voice sample; generating a synthetic voice sample using the normalized voice sample; training the machine learning model to identify whether received audio includes, a synthetically generated voice sample using the voice sample and the synthetic voice sample; and outputting the trained machine learning model.

In Example 9, the subject matter of Example 8 includes, wherein the voice sample is positively weighted for training the machine learning model.

In Example 10, the subject matter of Examples 8-9 includes, wherein the synthetic voice sample is negatively weighted for training the machine learning model.

In Example 11, the subject matter of Examples 8-10 includes, receiving a second voice sample from a person other than the employee, and determining whether the second voice sample is a match using the trained machine learning model.

In Example 12, the subject matter of Examples 8-11 includes, testing a second voice sample from the employee, and determining whether the second voice sample is a match using the trained machine learning model.

In Example 13, the subject matter of Examples 8-12 includes, wherein the voice sample includes a set of voice samples including at least two voice samples of differing duration.

In Example 14, the subject matter of Examples 8-13 includes, wherein the voice sample includes a low quality verification test sample with background noise.

Example 15 is a system for training a machine learning model to detect a fraudulent attempt to mimic an employee using a synthetic voice copy, the system comprising: processing circuitry; and memory, including instructions, which when executed by the processing circuitry, cause the processing circuitry to perform operations comprising: receiving a voice sample of an employee of an enterprise; normalizing the voice sample; generating a synthetic voice sample using the normalized voice sample; training the machine learning model to identify whether received audio includes, a synthetically generated voice sample using the voice sample and the synthetic voice sample; and outputting the trained machine learning model.

In Example 16, the subject matter of Example 15 includes, wherein the voice sample is positively weighted for training the machine learning model.

In Example 17, the subject matter of Examples 15-16 includes, wherein the synthetic voice sample is negatively weighted for training the machine learning model.

In Example 18, the subject matter of Examples 15-17 includes, wherein the instructions further cause the processing circuitry to perform operations comprising receiving a second voice sample from a person other than the employee, and determining whether the second voice sample is a match using the trained machine learning model.

In Example 19, the subject matter of Examples 15-18 includes, wherein the instructions further cause the processing circuitry to perform operations comprising testing a second voice sample from the employee, and determining whether the second voice sample is a match using the trained machine learning model.

In Example 20, the subject matter of Examples 15-19 includes, wherein the voice sample includes a set of voice samples including at least two voice samples of differing duration.

Example 21 is a method for detecting a spoofing attempt of a customer vocalization, the method comprising: receiving a call at a help desk system, the call including an origination number; during the call, recording at least one personal identifier from a caller on the call; determining a device identifier associated with the origination number; querying, using processing circuitry, a database of device identifiers to determine whether the device identifier corresponds to the at least one personal identifier; and in response to determining that the device identifier corresponds to the at least one personal identifier, verifying the caller to the help desk system.

In Example 22, the subject matter of Example 21 includes, sending a request to a telephone network operator system to determine whether the origination number corresponds to the at least one personal identifier; and receiving a response to the request indicating whether the origination number corresponds to the at least one personal identifier; and wherein verifying the caller includes determining that the origination number corresponds to the at least one personal identifier.

Example 23 is a method for detecting a spoofing attempt of a customer vocalization, the method comprising: receiving a call at a help desk system, the call including an origination number; during the call, recording at least one personal identifier from a caller; sending a request to a telephone network operator system to determine whether the origination number corresponds to the at least one personal identifier; receiving a response to the request indicating whether the origination number corresponds to the at least one personal identifier; and in response to determining that the origination number corresponds to the at least one personal identifier, verifying the caller.

In Example 24, the subject matter of Example 23 includes, determining a device identifier associated with the origination number; and checking a database of device identifiers to determine whether the device identifier corresponds to the at least one personal identifier; and wherein verifying the caller includes determining that the device identifier corresponds to the at least one personal identifier.

Example 25 is at least one machine-readable medium including instructions that, when executed by processing circuitry, cause the processing circuitry to perform operations to implement of any of Examples 1-24.

Example 26 is an apparatus comprising means to implement of any of Examples 1-24.

Example 27 is a system to implement of any of Examples 1-24.

Example 28 is a method to implement of any of Examples 1-24.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method for training a machine learning model to detect a fraudulent attempt to mimic an employee using a synthetic voice copy, the method comprising:
receiving a voice sample of an employee of an enterprise;
normalizing the voice sample;
generating a synthetic voice sample using the normalized voice sample;
training the machine learning model to identify whether received audio includes a synthetically generated voice sample using the voice sample and the synthetic voice sample; and
outputting the trained machine learning model.

2. The method of claim 1, wherein the voice sample is positively weighted for training the machine learning model.

3. The method of claim 1, wherein the synthetic voice sample is negatively weighted for training the machine learning model.

4. The method of claim 1, further comprising receiving a second voice sample from a person other than the employee, and determining whether the second voice sample is a match using the trained machine learning model.

5. The method of claim 1, further comprising testing a second voice sample from the employee, and determining whether the second voice sample is a match using the trained machine learning model.

6. The method of claim 1, wherein the voice sample includes a set of voice samples including at least two voice samples of differing duration.

7. The method of claim 1, wherein the voice sample includes a low quality verification test sample with background noise.

8. At least one non-transitory machine-readable medium including instructions for training a machine learning model to detect a fraudulent attempt to mimic an employee using a synthetic voice copy, which when executed by processing circuitry, cause the processing circuitry to perform operations comprising:
receiving a voice sample of an employee of an enterprise;
normalizing the voice sample;
generating a synthetic voice sample using the normalized voice sample;
training the machine learning model to identify whether received audio includes a synthetically generated voice sample using the voice sample and the synthetic voice sample; and
outputting the trained machine learning model.

9. The at least one non-transitory machine-readable medium of claim 8, wherein the voice sample is positively weighted for training the machine learning model.

10. The at least one non-transitory machine-readable medium of claim 8, wherein the synthetic voice sample is negatively weighted for training the machine learning model.

11. The at least one non-transitory machine-readable medium of claim 8, further comprising receiving a second voice sample from a person other than the employee, and determining whether the second voice sample is a match using the trained machine learning model.

12. The at least one non-transitory machine-readable medium of claim 8, further comprising testing a second voice sample from the employee, and determining whether the second voice sample is a match using the trained machine learning model.

13. The at least one non-transitory machine-readable medium of claim 8, wherein the voice sample includes a set of voice samples including at least two voice samples of differing duration.

14. The at least one non-transitory machine-readable medium of claim 8, wherein the voice sample includes a low quality verification test sample with background noise.

15. A system for training a machine learning model to detect a fraudulent attempt to mimic an employee using a synthetic voice copy, the system comprising:
processing circuitry; and
memory, including instructions, which when executed by the processing circuitry, cause the processing circuitry to perform operations comprising:
receiving a voice sample of an employee of an enterprise;
normalizing the voice sample;
generating a synthetic voice sample using the normalized voice sample;
training the machine learning model to identify whether received audio includes a synthetically generated voice sample using the voice sample and the synthetic voice sample; and
outputting the trained machine learning model.

16. The system of claim 15, wherein the voice sample is positively weighted for training the machine learning model.

17. The system of claim 15, wherein the synthetic voice sample is negatively weighted for training the machine learning model.

18. The system of claim 15, wherein the instructions further cause the processing circuitry to perform operations comprising receiving a second voice sample from a person other than the employee, and determining whether the second voice sample is a match using the trained machine learning model.

19. The system of claim 15, wherein the instructions further cause the processing circuitry to perform operations comprising testing a second voice sample from the employee, and determining whether the second voice sample is a match using the trained machine learning model.

20. The system of claim 15, wherein the voice sample includes a set of voice samples including at least two voice samples of differing duration.
